(19) United States
(12) Patent Application Publication
(10) Pub. No.: US 2017/0103441 A1
(43) Pub. Date: Apr. 13, 2017

(54) Comparing Business Documents to Recommend Organizations

(71) Applicants: Kurt Robert KOLB, Burnaby (CA); Maziyar HAMDI, Vancouver (CA)

(72) Inventors: Kurt Robert KOLB, Burnaby (CA); Maziyar HAMDI, Vancouver (CA)

(73) Assignee: GASTOWN DATA SCIENCES, Vancouver (CA)

(21) Appl. No.: 14/877,774

(22) Filed: Oct. 7, 2015

(51) Int. Cl. G06Q 30/06; G06F 17/30

(52) U.S. Cl. CPC G06Q 30/0627; G06F 17/30011; G06F 17/30864

(57) ABSTRACT

A computer method and system match buyer requirements to Evidence Documents of vendors. The system comprises a database of Evidence Documents and organizations. A user may enter their requirements using natural language, which the system analyzes to determine which Evidence Documents are most relevant.

### BACKGROUND

In the area of Business-to-Business (B2B) procurement, it is common for businesses, as a buyer, to search for vendors to provide new services or products. This is typically done using Internet search Engines, industry directories, and review sites. The buyer is then confronted with determining which of the many firms are best for themselves. Some websites of firms indicate services and provide sales material, however, the buyer has no easy way to compare firms or evaluate the claims of the firm.

Moreover, the buyer may have specific requirements for a project, which are not searchable by search Engines, directories, or review sites. At best the buyer could try to convert their project needs into search keywords or filter selections. The search results will be limited to vendors tagged with those keywords or filterable by the few filter options.

However, a buyer searching for a vendor may discover thousands of possible vendors, each of which may have dozens of case studies on their website. Thus because case studies are not centralized, a buyer would have to decide on or narrow down to a set of vendors, then read all of their case studies on their websites, in order to determine which vendors are relevant to the buyer and sought services/products.

### BRIEF SUMMARY

The inventors have appreciated that the process can be improved by providing a Natural Language Processing system for determining which vendors are most suited for a client based on their Evidence Documents.

According to one innovative aspect, certain exemplary embodiments provide a computer-implemented method including: one or more processors receiving a Requirement Document from a user; the one or more processors comparing the Requirement Document to Evidence Documents in a database to determine a set of similar Evidence Documents; and the one or more processors communicating a plurality of the similar Evidence Documents to the user. The Requirement Document has text describing an organization's requirement for a product or service. The Evidence Documents has text describing a product or service already provided by a vendor.

According to another innovative aspect, certain exemplary embodiments provide a computer-implemented method including: one or more processors receiving an Evidence Document from a user; the one or more processors comparing the Evidence Document to Requirement Documents in a database to determine a set of similar Requirement Documents; the one or more processors communicating a plurality of the similar Requirement Documents to the user; the one or more processors receiving a selection from the user of one or more of the communicated Requirement Documents; the one or more processors identifying which buyers are associated in the database with the selected Requirement Documents and communicating identities of the buyers to the user.

According to another innovative aspect, certain exemplary embodiments provide a computer-implemented method including: one or more processors identifying a first document describing services required or performed by a first organization; the one or more processors identifying, from a database, a set of similar documents having text features similar to the first document; the one or more processors communicating a plurality of the similar documents to a user associated with the first organization; the one or more processors receiving a selection from the user of one or more of the communicated similar documents; the one or more processors identifying which second organizations are associated, in the database, with the selected similar documents and providing a communication agent for the user to contact these second organizations.

Other embodiments of the above aspects include a computer system having one or more computer processors and a computer-readable storage device having stored thereon instructions, which, when executed by the one or more processors, cause the computer to perform the method.

This summary does not necessarily describe the entire scope of all aspects. Other aspects, features and advantages will be apparent to those of ordinary skill in the art upon review of the following drawings and description of specific embodiments.

### BRIEF DESCRIPTION OF THE DRAWINGS

The invention may be exemplified by the following figures, in which like reference numerals refer to similar elements.

FIG. 1 is an illustration of client and server software agents.

FIG. 2 is an illustration of a data structure for recording Evidence Documents, Requirements, relationships and organizations.

FIG. 3 is a flowchart for matching Requirement Documents to Evidence Documents.

FIG. 4 is an illustration of topic modeling and inference.

FIG. 5 is an illustration of selecting relevant cases and vendors.

FIG. 6 is a user-interface for entering requirements and receiving matching Evidence Documents.

FIG. 7 is an illustration of matching documents comprising multiple parts.

FIG. 8 is an illustration of matching multiple requirements to multiple Evidence Documents.

FIG. 9 is a flowchart for improving an Evidence Document.

FIG. 10 is a user-interface for entering requirements and selecting generic statements related to the requirements.

FIG. 11 is an illustration for matching user requirements and search criteria to documents.

FIG. 12 is (a) a flowchart of iterative topic selection and (b) examples of objects to be displayed and selected by a user.

### DETAILED DESCRIPTION

The present system implements a server, database and system for matching the requirements of a buyer to Evidence Documents of vendors, which are then used in a recommendation of vendors. Buyer requirements are received by the server as text, preferably written in natural language. The requirements may be for a particular project, task, or need of an organization looking to purchase satisfying products or services. The requirement may be a document such as an RFI, RFQ, or RFP (Request for Information, Quote or Proposal). The Requirement may comprise separate, structured parts such as the buyer's industry, questions for vendors, buyer background and current situation, a detailed explanation of the services or products required and/or the goals.

Providing database 5 comprising data about vendors, clients, relationships, and Evidence Documents improves the vendor recommendation process by enabling processing examples of how vendors are relevant to the buyer's requirements. This data might not have been known or considered by the users without the systems help. This data is used to match a buyer's requirements to vendors using the buyer-user's own words.

A user provides a Requirement Document comprising details explaining a project/RFP/task or general requirement for which they wish to identify vendors to provide a service or product. The database comprises records of vendors and associated Evidence Documents, each with details of services previously provided to clients.

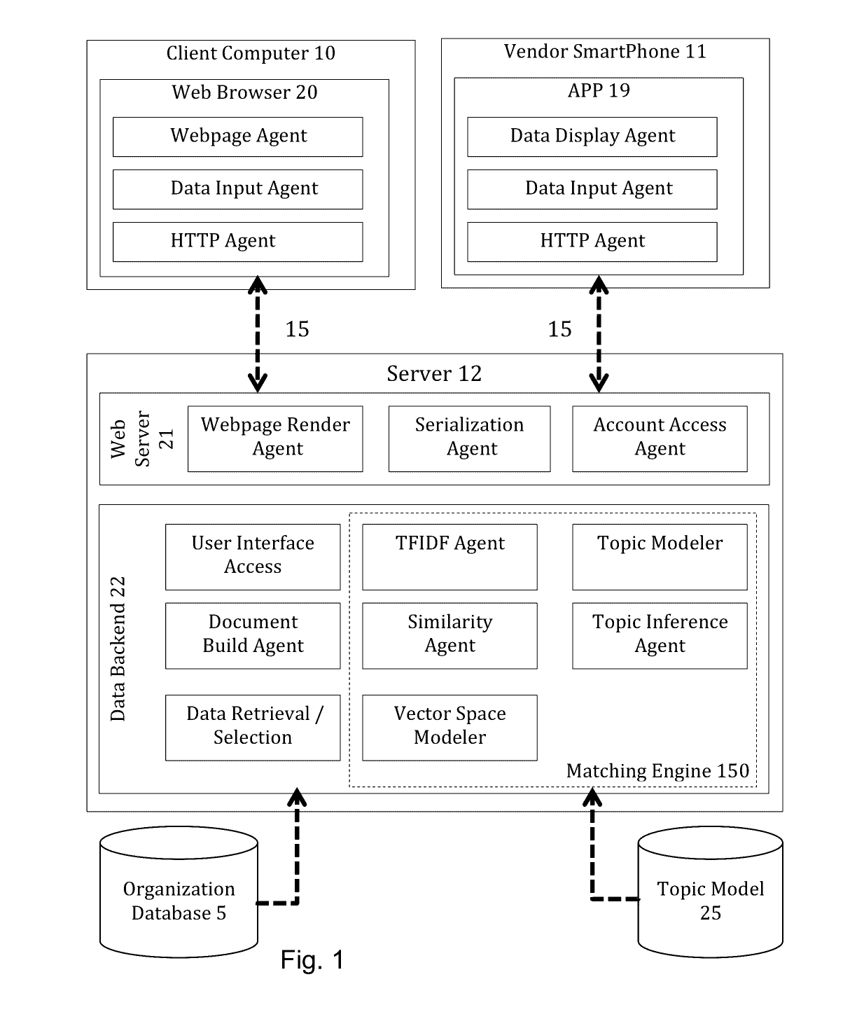

A system, network, and computer program are implemented to capture organization attributes, Evidence Documents, and relationships between organizations. The Evidence Document data may be a part of the relationship data object or stored separately. The database is structured to connect millions of organizations to each other by business relationship and Evidence Documents to create network. FIG. 1 illustrates an example data structure of a graph storing and connecting organizations, Evidence Documents and requirements.

A server 12 comprises one or more processors for reading instructions from computer-readable storage media and executing the instructions to provide the methods and agents described below. Examples of computer readable media are non-transitory and include disc-based media such as CD-ROMs and DVDs, magnetic media such as hard drives and other forms of magnetic disk storage, semiconductor based media such as flash media, random access memory, and read only memory.

An organization is generally used herein to refer to a legal entity providing or receiving products or services. While an organization may typically be a business, the term includes but is not limited to charities, corporations, sole proprietors, Non-Government Organizations (NGO), institutions, government departments, and partnerships. The term vendor is used herein to refer to organizations that supply products or services in a business relationship, notwithstanding that they may also consume products or services in another relationship. A business relationship is used herein to refer to a business-to-business (B2B) relationship or commercial transactions between organizations to provide those products or services. The relationship may represent an agreement, which, for example, may subsist in a contract, a terms-of-business document or an ongoing understanding. The business relationships stored in the database may represent relationships that have been ongoing for at least three months or have at least three repeat instances of transactions. This is in contrast to personal relationships, non-commercial relationships, click-thru data or user website activity data, or one-off commercial transactions.

The organizations may be termed clients (aka consumers, buyers) or vendors (aka suppliers) to indicate their status with respect to a B2B relationship or Evidence Document for supply of products for services. Rather than store the client/vendor status with the organization data object, the status may be stored with the relationship or product/service data object because an organization may be a vendor in one relationship and a client in another. As used herein, a buyer is an organization using the present system to find and buy products and services.

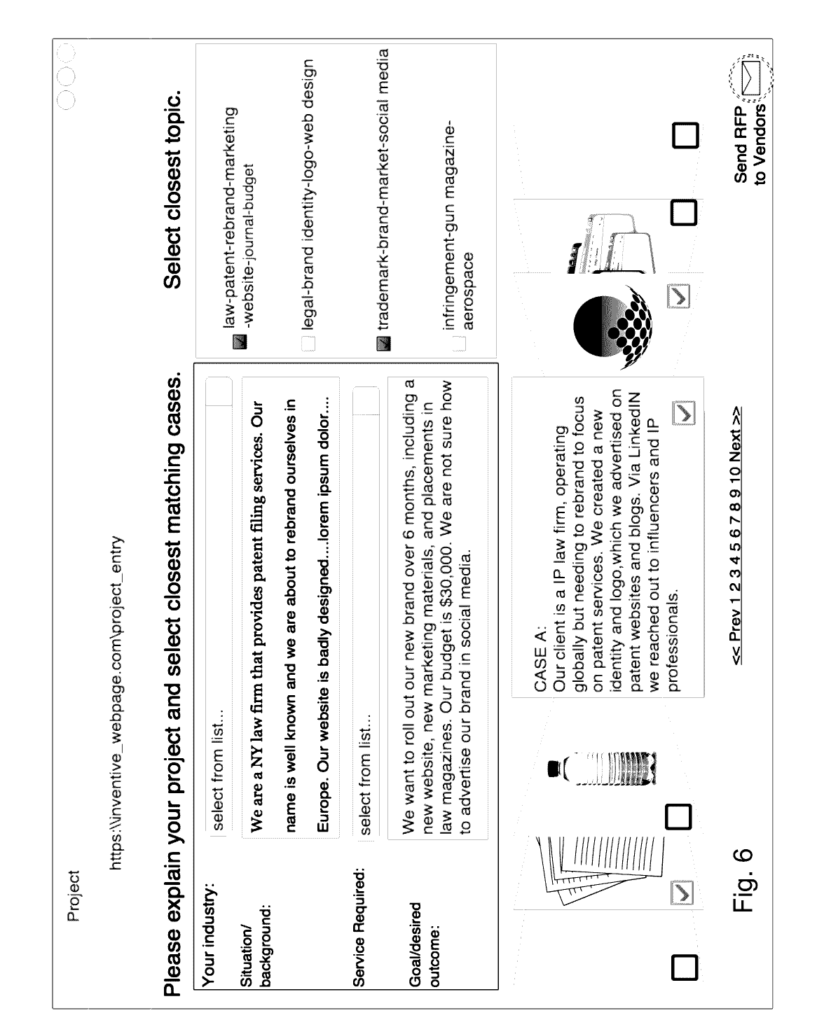

An Evidence Document describes a real example of how a vendor provided products or services to a client to achieve certain results. Evidence Documents may comprise text detailing of the client background, the vendor's methodology used, and results for the client. An example case is shown in FIG. 6. The more details that are given, the easier it is for a buyer-user to determine if the evidence is relevant and to their own situation and goals. An Evidence Document may comprise images, logos, web designs, and samples of work. In order to process and compare non-text evidence, the system or user adds text as the Evidence Document or assigns tags to the Evidence Document, which are then stored in the database.

A user is generally used herein as a person who interacts with a computer, typically entering text for their requirements or Evidence Document and selecting matching topics, buyers or vendors. The user is expected to be associated with a particular organization either seeking information as a potential client (buyer) or providing information as a vendor. Herein the term ‘buyer-user’ is used to refer to a user acting on behalf of a potential buyer and ‘vendor-user’ is used to refer to a user acting on behalf of a vendor. There may be many buyer-users and vendor-users operating the system simultaneously for their own purposes.

FIG. 1 illustrates the interaction between a client-computing device 10/11 and the server 12 over network link 15. The devices 10, 11 may communicate via a web browser 20 or smart APP 19, using software agents to receive input from the user, make HTTP requests and display data. The server 12 may be a reverse proxy server for an internal network, such that the client device 10 communicates with an Nginx web server 21, which relays the client's request to backend processes 22, associated server(s) and database(s) 5, 25. Within the server, software agents retrieve organization identity and Evidence Documents, build and interpret the document models, and provide user interface controls. Some software agents may operate within a notional web server to manage user accounts and access, serialize data for output, render webpages, and handle HTTP requests from the devices 10, 11.

Users may access the databases remotely using a desktop or laptop computer, smartphone, tablet, or other client computing device 10 connectable to the server 12 by mobile internet, fixed wireless internet, WiFi, wide area network, broadband, telephone connection, cable modem, fibre optic network or other known and future communication technology using conventional Internet protocols.

The web server will use the serialization agent to convert the raw data into a format requested by the browser. Some or all of the methods for operating the database may reside on the server device. The devices 10,11 may have software loaded for running within the client operating system, which software is programmed to implement some of the methods. The software may be downloaded from a server associate with the provider of the database or from a third party server. Thus the implementation of the client device interface may take many forms known to those in the art. Alternatively the client device simply needs a web browser and the web server 12 may use the output data to create a formatted web page for display on the client device. The devices and server may communicate via HTTP requests.

The methods and database discussed herein may be provided on a variety of computer system and are not inherently related to a particular computer apparatus, particular programming language, or particular database structure. The system is capable of storing data remotely from a user, processing data and providing access to a user across a network. The server may be implemented on a stand-alone computer, mainframe, distributed network or over a cloud network.

### Database Format

The database may be implemented in a variety of ways known within computing science, such as an object database, relational database or a graph database. As used herein a collection of data about an organization/relationship/Evidence Document is called a data object, without limitation to a specific data schema. As this method is implemented on a computer, references herein to operations with organizations, relationship, and Evidence Documents are to the related data object.

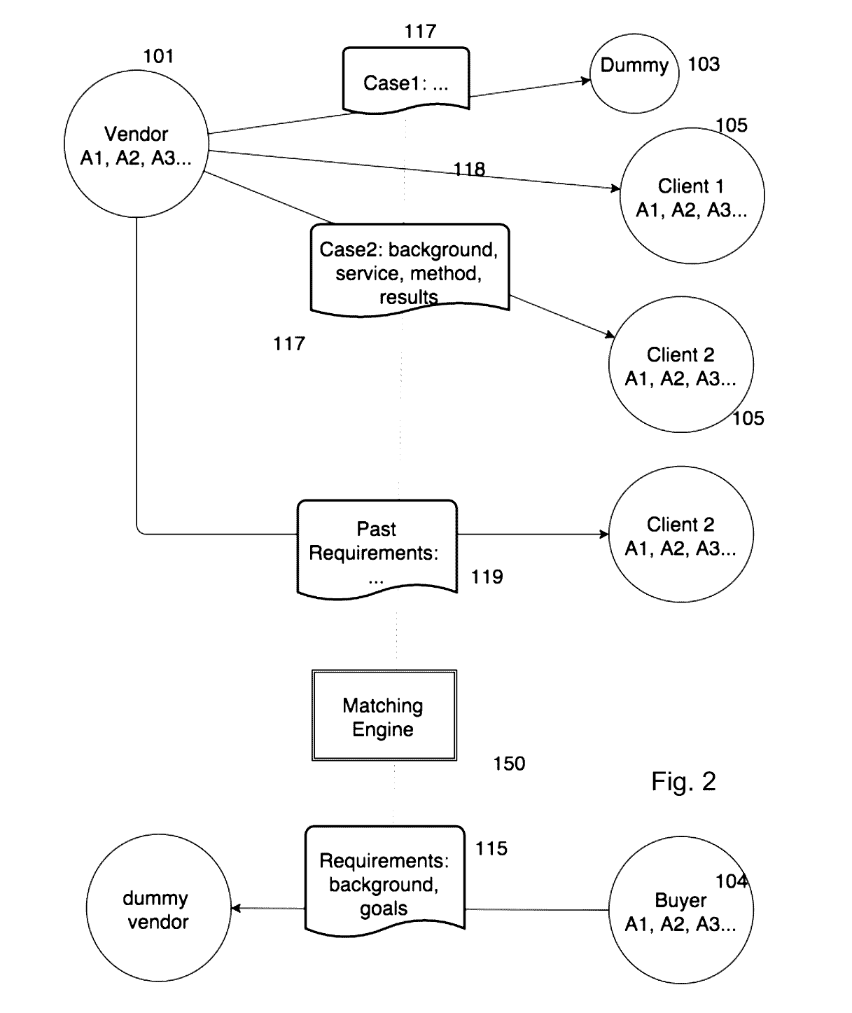

FIG. 2 illustrates an example data structure of a graph whereby organizations, Evidence Documents and requirements are stored as nodes, and edges connect the vendor organizations to their Evidence Documents and connect client organizations to their requirements.

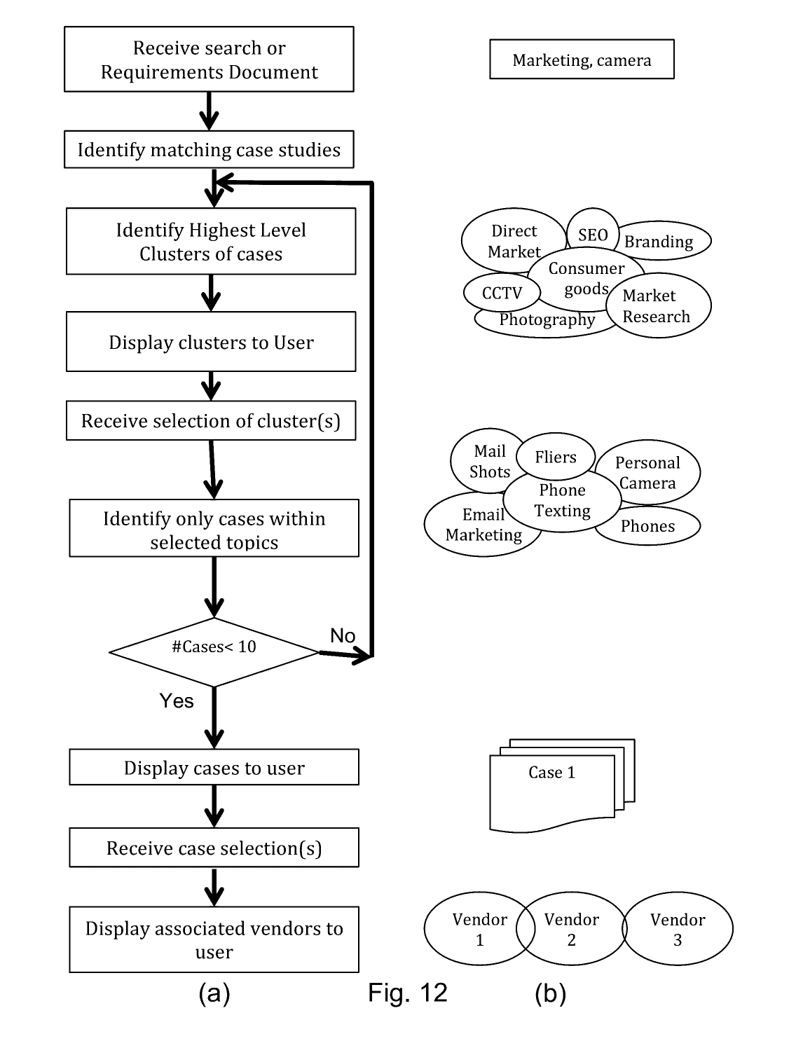

In some embodiments, a graph database is used, wherein organizations are stored as nodes and business relationships are stored as edges. Evidence Documents may be stored with the edge data object or as its own data object connected to associated organizations. This is illustrated in FIG. 12 with organization circles 101-105 with arrows as relationship edges 115-119 to indicate the direction of the flow of goods or services from a vendor to a client.

Dummy organizations may be used to complete a relationship record if there is no known organization. For example, a vendor may wish to keep the identity of the client a secret and an open Requirement Document 115 will not have a vendor associated yet. Relationship edge 118 has no Evidence Document recorded with it. Each organization data object may comprise a plurality of attributes A1, A2 . . . An to record data such as location, size, age, industry, services, products, brands, and revenue.

The system stores data for organizations in the database and can find or compare organizations depending on the nature of the data. The organization data may be conceptually divided into different categories:

Identification data that enable the system to identify the organization. Identification data includes data such as legal name, parent company name, CEO's name, office address, IP address, logos, brand names, or company registration number;

Profile information about the organization history, expertise, and accomplishments, possibly in an unstructured text format;

Attribute data that describe properties of the organization using categories or values, but do not identify the organization. Attribute types comprise industry, sector, general location, specialization, product category, service category, number of employees, market capitalization, field of practice, or revenue; and

Business segment data, as a subset of attribute data, for describing the business function or division of an organization that includes attribute types such as industry, sector, specialization, product class, service class, or field of practice.

### Matching Engine

The present system provides a method for finding organizations by matching a document created by a first organization to one or more other documents created by second organizations to discover the most relevant second organizations. The system is arranged for organizations on one side of the buyer-vendor relationship to find organizations on the other side. Matching organizations starting from either perspective is contemplated. The server comprises a Matching Engine, software that provides several functions, including retrieving documents from the database and comparing these to the first organization's document.

The recommendation of vendors for a buyer depends on the relevance of vendor Evidence Documents to the requirements of the buyer-user. The Matching Engine compares the Requirement Document to the collection of Evidence Documents to calculate similarity scores, preferably in real-time. The Matching Engine identifies the most similar Evidence Documents (or most similar clusters of Evidence Documents) and communicates details of these to the buyer-user.

Documents similarity may be calculated by many ways known in computer science. Typically a collection of second documents is modeled offline and a similarity score is calculated in real-time between a first document and a plurality of second documents in the collection or a cluster of those second documents. Common techniques for modeling may be divided into topic modeling (such as Latent Dirichlet Allocation (LDA, LLDA, pLDA), Non-Negative Matrix Factorization (NMF)) or vector space modeling, such as semantic similarity or term similarity.

The vector space model represents a document as a vector of features (words or n-grams) whilst a topic model represents a document as a probability of discussing certain topics. Both models may include pre-processing steps to filter out stop words, seed the model with known keywords and/or reduce the number of features using principle component analysis (PCA) or latent semantic analysis (LSA). Thus the model will not include common words (e.g. “and”, “if”, “the”), will include desirable keywords (e.g. marketing, legal, consulting), and will merge very similar words or synonyms into the same feature (e.g. advertising=adverts, ads, ad words, commercials)

As an example, Vector Modeling may be performed followed by a K-Nearest Neighbor (K-NN) algorithm to cluster documents with other documents that share many features. This model can determine for a Requirement Document, not only the nearest K Evidence Documents, but also to which cluster(s) of Evidence Documents the Requirement Document belongs. The nearest K Evidence Documents or an exemplary Evidence Document from each cluster may be displayed to the user for confirmation.

As an example, Topic Modeling, using LDA, is performed on a collection of Evidence Documents to discover a set of topics covering the documents in the collection. A topic is defined as a distribution over many words. A document is a collection of words and can be expressed as a probability of topics. The topics may have the effect of creating clusters of document, whereby each document in a cluster has a high probability of discussing that cluster's topic.

The topics and documents are not identified by a single word, unless LLDA is used, whereby topics are manually labeled. Topic features may be displayed to the user, referring to the most frequently used words for a topic, ignoring common words.

Term Frequency Inverse Document Frequency (TFIDF) is another method to discover and weight important, informative keywords in a collection of documents, by determining words that are frequently used in a document but infrequently used in the collection overall. The Matching Engine can infer that documents with the same keywords are similar. These keywords may be shown to the user as a concise representation of a document or collection of documents that describe a common specialty, industry, ability, service or product.

An advantage of topic modeling and semantic relatedness techniques is that two documents can be calculated as similar even though they have no overlapping words. Clusters of Evidence Documents with a common topic will, on aggregate, have similar distributions over the words. Also the modeling does not require supervised learning.

There is no hard ratio between the number of topics and documents. Typically, the number of topics (k) increases sub-linearly with number of documents (n) e.g., N_topics=square root of M_documents. In the present system, the desirable number of topics is on the order of the number of specialties that are offered by the vendors multiplied by the number of ways of approaching the specialties. For example, a system providing a recommendation of Marketing and Advertising firms offering about 20 specialties (SEO, brand identity, content marketing, etc.), each of which may be handled in ten ways (taking into account industrial niches and different vendor tactics) would need to cluster the Evidence Documents into about 200 topics. Having many more topics would mean some topics would be highly correlated or modeling noise. Having many less topics would mean confounding different Evidence Documents. The database should therefore comprise at least O(10⁴) Evidence Documents (e.g. 40,000) in order to train the model.

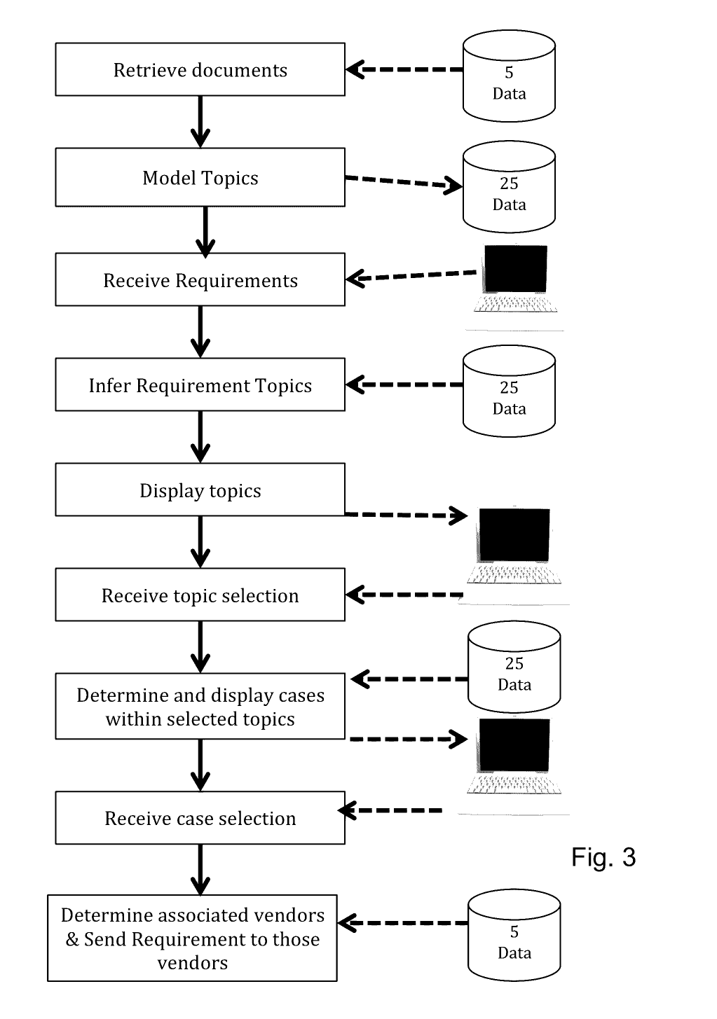

FIG. 3 is a flowchart for modeling topics and matching requirements to Evidence Documents to recommend vendor(s). The server retrieves documents from the B2B relationship database 5. The retrieved documents are Evidence Documents, and, optionally, Requirement Documents from other buyer-users. The server builds a model of topics and records this in memory, such as database 25. The model p may comprise (a) sets of word frequencies for each topic and (b) sets of probable topics for each document, creating two matrices: N_topics×P_words and M_documents×N_topics.

The server receives a Requirement Document from a buyer-user. The server infers the topics of the Requirement Document and displays the most probable topics. The server, via the UI, receives the user's selection of these topics, to create a set of confirmed topics.

Using the topic model, the Engine calculates a probability that each topic describes the Requirement Document to infer the topic(s) of the Requirement Document. These Evidence Documents are scored and the highest are displayed to the user. The server receives the user's selection of Evidence Documents. The server determines from the B2B relationship database 5 which vendors are associated with the user-selected Evidence Documents. The identities of the associated vendors are displayed to the user as a recommendation and/or the Requirement Document is sent to the associated vendors.

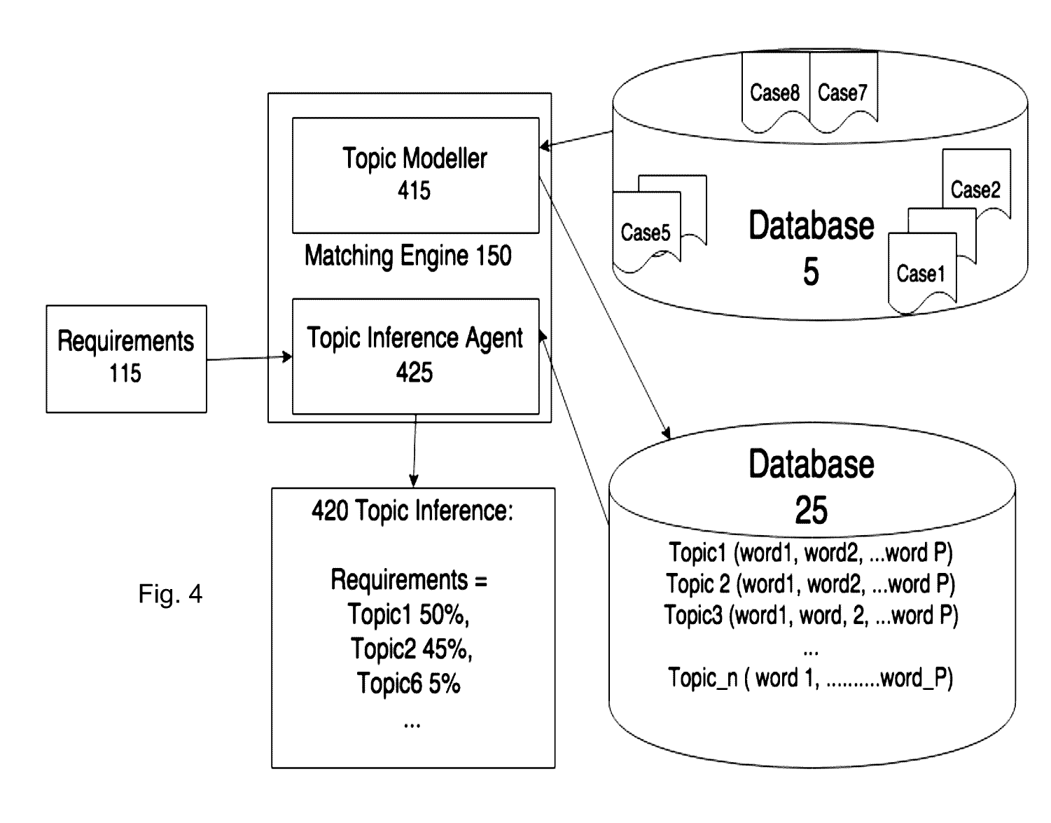

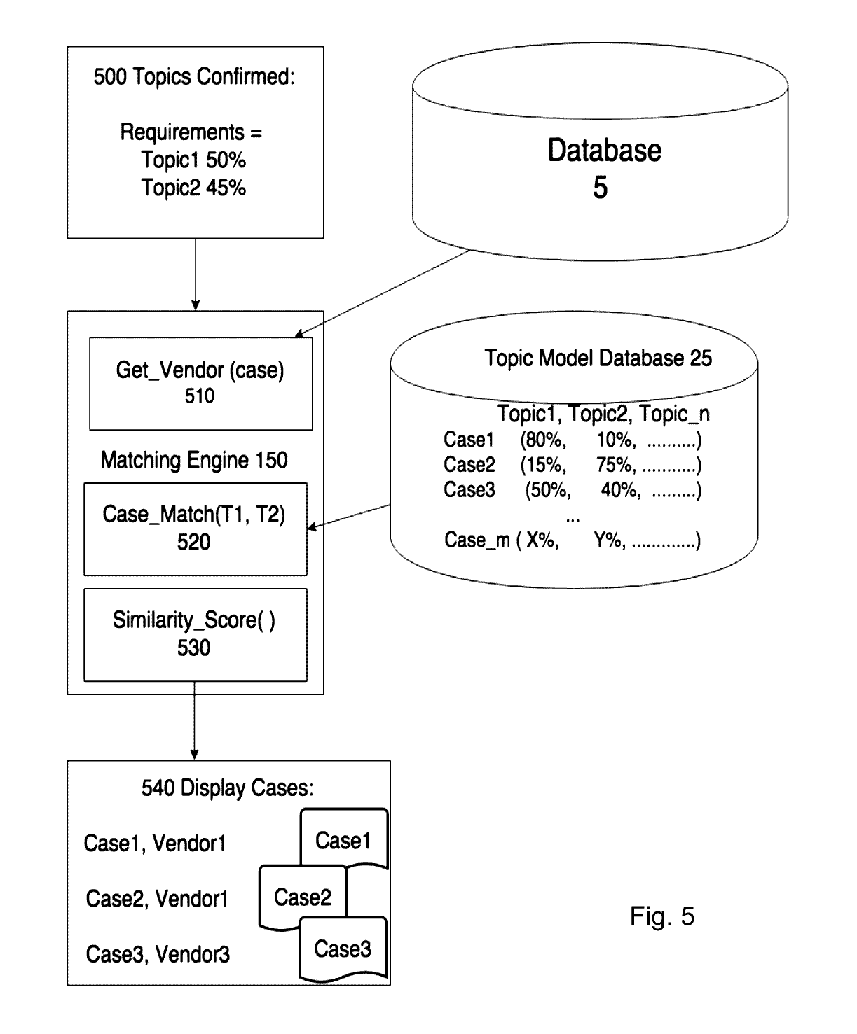

FIGS. 4 and 5 illustrate the elements used in the process of FIG. 3. FIG. 4 shows a block diagram showing the interactions between the databases 5, 25, the matching Engine 150 and Requirements 115 to infer topics 420. Potentially thousands of Evidence Documents are reduced to N topics, each described by P words. Here the Requirement Document likely discusses Topic 1 and 2, with Topic 6 shown but improbable. FIG. 5 shows a block diagram continuing the interactions once a user has confirmed the topics (500) as Topics 1 and 2. Agent 520 determines that Evidence Documents 1, 2, 3 are good examples of these topics. Agent 510 retrieves the Evidence Document and determines that Vendor 1 and 2 are associated with these Evidence Documents. Agent 530 scores the Evidence Documents based on their similarity to the Requirements 115 or topic distribution 420 and scores the vendors by their aggregated evidence scores. Serialization Agent 540 displays the vendors and evidence text to the user.

FIG. 6 is an example User Interface, which accepts a Requirement Document in the left side and displays the inferred topics on the right. The bottom portion displays Evidence Documents and samples of work, which are selectable for further user processing. The suggested topics may refer to the Requirement Document as a whole or for a portion.

To determine how many of the most probable topics to transmit to the user, the Engine may use rules, such as (a) a predefined number of topics with the highest probabilities, (b) the number of topics with the highest probabilities that may reasonably be displayed and read on the user's screen or (c) topics that have a probability above a threshold value. The Matching Engine may perform the topic inference and evidence display in real-time as words are entered, after the user has finished the document or part thereof. As long as there are insufficiently probable topics inferred, the user interface will indicate that the user should add more words.

The Engine uses a metric of document similarity between the Requirement Document and the Evidence Documents to recommend vendors to the buyer-user, either explicitly by naming the vendors associated with the most similar Evidence Documents or implicitly by displaying the most similar Evidence Documents themselves. In this latter mode, the buyer-user can select a vendor by relevance rather than by perceptions about the vendor.

In certain embodiments, Evidence Documents or a cluster of Evidence Documents can be represented and displayed to the user using dominant features in those Evidence Documents or clusters (from the TFIDF keywords or topic model features) or labels given to the clusters by an administrator. Alternatively the server may display an example Evidence Document from the cluster. The user interface comprises software for the user to select one or more Evidence Documents or clusters. If a cluster(s) is selected, the Matching Engine retrieves Evidence Documents within the selected cluster(s) and display at least a subset of them to the user.

In certain embodiment, the Matching Engine uses hierarchal clustering to organize the Evidence Documents into a plurality of cluster layers. This is advantageous where there are too many documents in a cluster to be displayed or otherwise understood by a user. Such large clusters are subdivided into sub-clusters, each sub-cluster having Evidence Documents more similar with each other than with Evidence Documents in other sub-clusters. Algorithms and best modes for implementing hierarchal clustering (such as hierarchal topic modeling) are known in the art. Commercial software is available from Matlab, NCSS, SAS and others.

Using hierarchal clustering, the Matching Engine may determine and display the super-clusters most similar to the requirements for the user to select those super-clusters that they like, then the Engine displays the sub-clusters from which the users selects again. This process is repeated until there are few enough Evidence Documents in a cluster for the Evidence Documents themselves to be displayed.

FIG. 12(a) is a flowchart for iteratively displaying and selecting clusters of Evidence Documents and FIG. 12(b) illustrates example clusters, Evidence Documents, and vendors for display. A user enters search criteria or a Requirement Document. The Matching Engine identifies a set of C Evidence Documents from the database that satisfy the search query or match the Requirement Document. Potentially there are thousands of matching Evidence Documents. Rather then score, rank and display only the best matching documents, in this embodiment, the system clusters (or classifies) the C matching Evidence Documents into S clusters, where S is less than C, preferably wherein S is less than 1/10 C. The number of clusters S to use may depend on the number of clusters that can feasibly be displayed on the user's device. The clustering may be done in real time on the limited set of matching Evidence Documents or may re-use a model created offline, displaying clusters having at least one matching Evidence Document. The clusters are displayed to the user, using the tags, topic headers, or features that represent each cluster.

The UI interface displays the cluster representation and is arranged to receive a selection of clusters from the user. Using this user-selection of clusters, the Matching Engine identifies the Evidence Documents within each selected cluster. The Matching Engine then determines clusters of the Evidence Documents within each selected cluster.

Hierarchal clustering may be used such that, for each iteration, the clusters are sub-clusters of the previous iteration. In the example shown, four clusters in the second iteration represent services below the “direct marketing” super-cluster that was selected, and two clusters represent products below the “consumer goods” super-cluster. However the Engine may be implemented such that, during each iteration, the remaining Evidence Documents are re-clustered, without using a hierarchy.

The process of displaying and selecting clusters of Evidence Documents is repeated until there are few enough Evidence Documents in the selected clusters, that the Evidence Documents themselves can be displayed. Thus the Engine check whether the number of remaining Evidence Documents M is less than a threshold (the threshold is 10 in FIG. 12(a)). The Engine then displays the Evidence Documents to the user via the UI; the UI being arranged to receive a selection of Evidence Documents. The Engine may then determine and display vendors associated in the database with the selected Evidence Documents. In this way, the user has selected vendors using their Evidence Documents to narrow the selection.

In an alternative embodiment, both the Evidence Documents and Requirement Document are divisible into multiple cross-comparable parts, preferably wherein at least some of the parts of an Evidence Document are directly comparable with a part of the Requirement Document. A comparison of document similarity is performed on a part-by-part basis. Topic modeling is performed on each part of the Evidence Documents separately and topic identification of the Requirement Document done for each part.

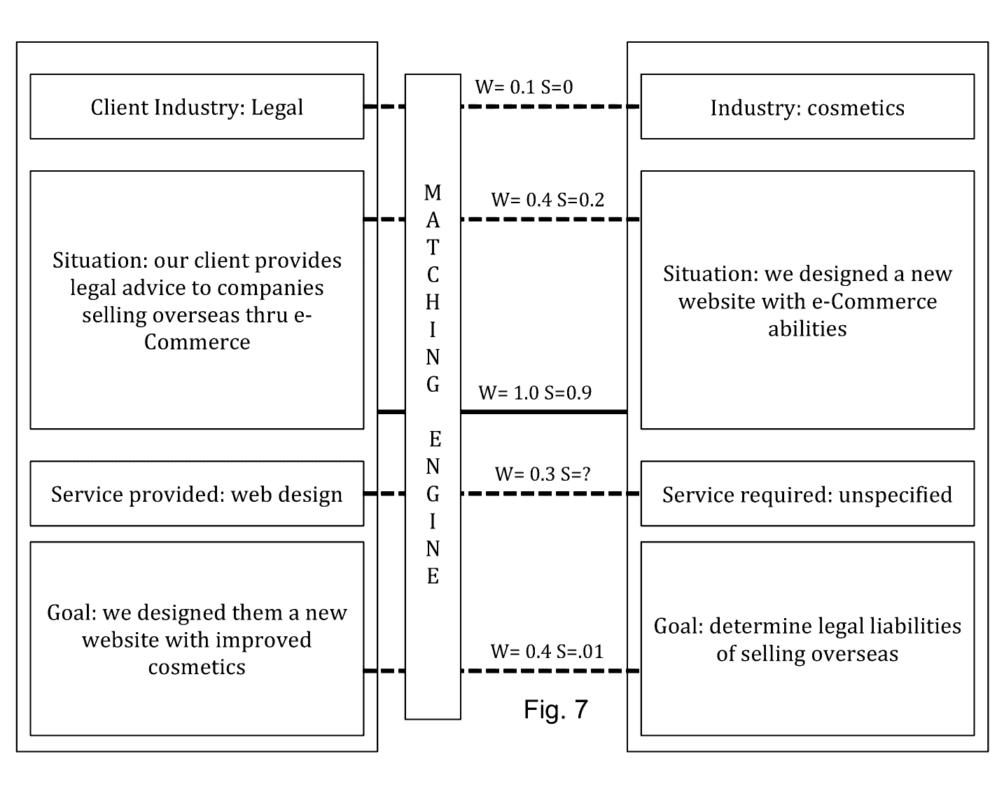

FIG. 7 illustrates a Matching Engine comparing documents with the requirements on the left and an Evidence Document on the right. The solid line demonstrates that comparing documents in their entirety can lead to an incorrect inference that these are highly similar because the Engine can find many overlapping words somewhere in the documents. Alternatively, the dotted lines show how the Engine may compare documents part-by-part to reach the opposite conclusion, i.e. that the documents are NOT similar, because the matching keywords are findable but in the opposite parts of situation and goal of the two documents.

This refinement avoids potentially confounding keywords in the situation part with the goals part. For example, a keyword may describe the current satisfactory situation, not to be confused with the service needed or a result desired. This ensures that the situations are the same and the results are the same. In this case, the total similarity score is a weighted (W) combination of part-by-part similarity scores (S).

Multi-part documents may be a form of hierarchal clustering if subsequent parts represent divisions of the previous part. For example, there may be two parts, situation and results, wherein results (sub-cluster) are specific solutions to a cluster of problems defined by the situation (super-cluster). The Engine therefore determines and displays clusters of similar situations from which the user can select. The Engine then determines and displays clusters of results that solved the user-selected situations. The document model and process may be reversed, whereby the Engine first determines and displays clusters of similar results and then determines and displays situations that required the user-selected results.

### Multiple Matching

In an alternative embodiment, the Matching Engine takes into consideration a plurality of Requirement Documents from a single buyer and a plurality of Evidence Documents from a single vendor. This allows a buyer to divide their needs into a plurality a smaller projects or aspects of the company that need help. Similarly the vendor can explain their separate services with more detailed, specific examples. The Matching Engine matches requirements to Evidence Documents individually, as explained above or makes a holistic match to find a vendor that would best be able to service many of the needs of the buyer.

Using the above matching techniques, the Matching Engine calculates document similarity between a plurality of Requirement Documents and a plurality Evidence Documents from each vendor. The Engine sums the document similarity scores for a single vendor to calculate an overall vendor score. The Engine may ignore document similarity scores below a threshold value, so that many bad matches do not contribute towards a high vendor score.

A set of vendors having the highest vendor scores is displayed to the buyer-user. The set may comprise vendors that are highly matched to one requirement of the buyer or are on aggregate a good match to the buyer's overall requirements. The display may indicate the degree and particular aspects that are a match.

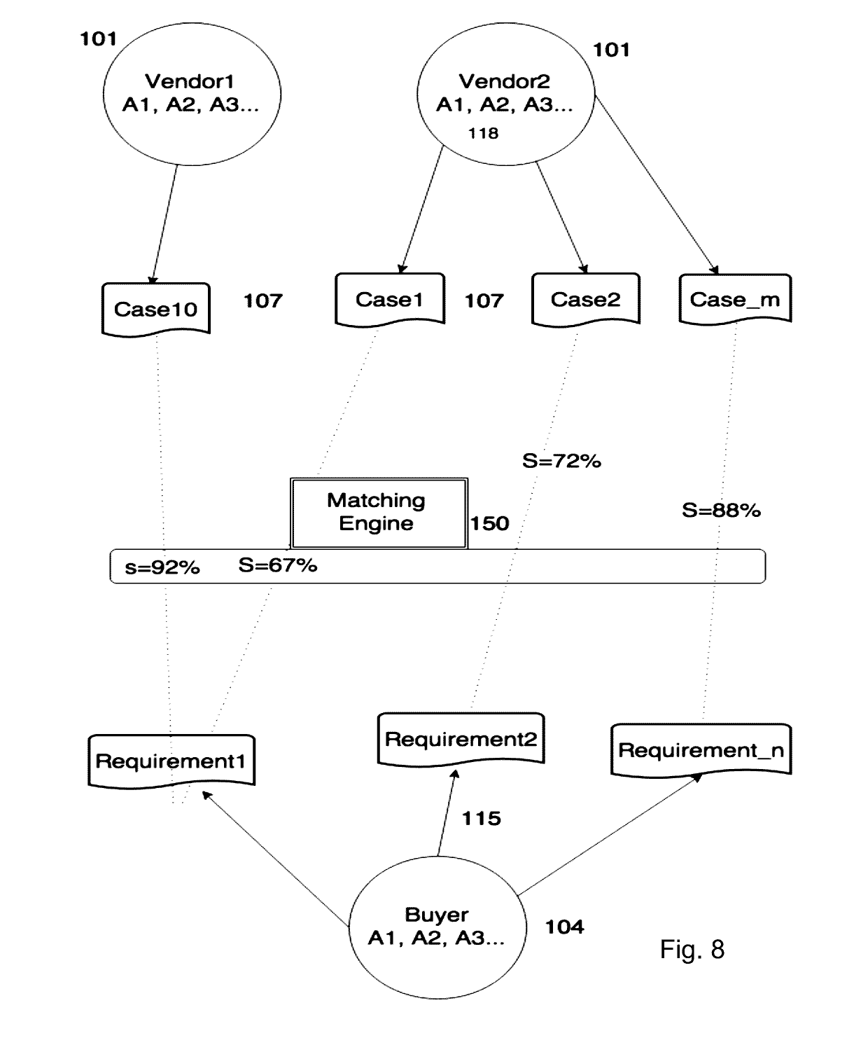

FIG. 8 illustrates documents for buyers and vendors being matched. Vendor1 is the best match for Requirement 1 and Vendor2 is the best match for the buyer's overall requirements. Of course the user might select Vendor1 to complete Requirement 1 and Vendor2 to handle the remaining projects.

### Past Requirements Documents

Optionally the document modeler agent may include active and closed Requirement Documents. This makes the model more across the entire landscape of services/products/projects and also ensures that the model includes vocabulary that a buyer-user might use that might not be typical of vendor-users.

Once a buyer's requirement has been linked to a successful vendor that provides the required services or products, the database is updated to record this. The server amends the database by connecting the requirement data object to the vendor data object (replacing the dummy vendor, if used).

The user may indicate that an Evidence Document in the database is related to a buyer's Requirement Document. The document modeler may use this relation in verifying the model by determining if both the Evidence Document and requirement were assigned to the same topic or have semantic relatedness, as one would expect.

The matching Engine can display an Evidence Document when its associated Requirement Document is highly matched to a buyer-user's Requirement Document. Thus if buyers tend to use similar vocabulary in their requirements, the matching Engine can find similar past requirements to recommend a vendor, even though the vendor did not use that vocabulary.

Thus in one embodiment, the Matching Engine matches a new Requirement Document to past Requirement Documents that have been successfully fulfilled by a vendor, separately or as part of the Evidence Document matching process. In an example process: a buyer-user enters a Requirement Document 115; the Matching Engine 150 retrieves from the database a set of past Requirement Documents 119 (from other clients) that have now been linked to vendors 101; the Matching Engine determines which past Requirement Documents are similar to the new Requirement Documents and displays the past Requirement Documents, the associated Evidence Document or associated vendors to the user; the server receives the user's selection of vendors that serviced the past Requirement Documents that best match their needs; and, if requested, the server sends the new Requirement Document to the selected vendors.

An effect is to show past Requirement Documents to the user, which may influence them to write a more thorough document and to find vendors that were successful in completing similar projects. When the database contains an Evidence Document from the vendor related to the past Requirement Document, this additionally informs the user of how the project was completed and what the result was.

### Buyer Initiated Selection

Whilst one goal of the system may be to suggest vendors to potential clients, the identity of the vendor may be disclosed to the user at one or more points in the workflow. As discussed above, the server may display or otherwise communicate to the buyer-user topics or Evidence Documents that are similar to the Requirement Document and may simultaneously display the associated vendors.

Thus the buyer-user can select vendors explicitly or implicitly through their associated Evidence Documents. The selection process may be done via a user interface on a website but may also be done in a software program installed on the user's computer or via email comprising URLs to direct the server that a particular user has selected a particular vendor.

In one embodiment, the user selects a plurality of vendors from a list provided by the system, either as a directory of relevant vendors or a set of ranked vendors. The client-user determines which of the vendors appear to be attractive to the potential client and requests that the system send those vendors the Requirement Document.

### Vendor Initiated Selection

The recommendation method may also be initiated by a vendor-user. Thus in certain embodiments, the Matching Engine determines which of a plurality of Requirement Documents are most similar to an Evidence Document of a vendor, effectively operating in reverse from the above matching scheme. The Requirement Document is entered and stored in database 5, posted to an electronic marketplace or is communicated to a plurality of vendors.

This process may be initiated by a vendor-user entering a new Evidence Document or requesting that the server find new clients. Otherwise the system may initiate the process periodically on existing Evidence Documents. The Matching Engine retrieves an Evidence Document from the database and finds a plurality of active Requirement Documents (i.e. Requirement Documents that are not withdrawn or not currently being satisfied by a vendor) that are similar to the Evidence Document.

As taught above, the comparison may be based on multi-part documents or multiple documents of each party.

As taught above, the server may display topics or clusters of Requirement Documents to the vendor-user for selection or to narrow down the best matching Requirement Documents which are then communicated to the vendor-user.

The Matching Engine may use topic modeling, whereby a topic model is built from a collection of active Requirement Documents and, optionally, including closed Requirement Documents and Evidence Documents. Including these optional documents helps to build a more robust model encompassing the whole landscape of possible projects/services/products rather than the far fewer Requirement Documents that are active. The Matching Engine communicates the active Requirement Documents that are most similar, preferably using inclusion/exclusion rules as discussed above. A further advantage of using all Requirement Document and Evidence Documents is that the topic model for vendor-initiated and buyer-initiated matching may be shared.

If a vendor-user is interested in the Requirement Document, they may elect to respond. Such a response may include an explanation of their best selling points, prices, or strategy. For example, Evidence Documents that illustrate why the vendor is relevant to the buyer or their project may be selected by the vendor-user for inclusion. The system may then send all responses, or the top responses, to the user associated with the potential client. Methods for automating a response using data stored on the database are explained in detail in co-pending patent application DOCKET P009US*.

### Mutual Matching and Communication

A combination of vendor-initiated and buyer-initiated matching may be performed in certain embodiments. In this case, Requirement Documents and Evidence Documents in the database are continually being matched and communicated to both vendor and buyers. For example, a new Requirement Document is matched to recorded Evidence Documents and/or a new Evidence Document is matched to recorded Requirement Documents. In either case, both vendors and buyers are notified. The recommendations to each party are not necessarily symmetrical, as a vendor might receive a bigger set of matches than a buyer (or vice versa) and the rank will depend on the relative similarity values in each party's set.

### Scoring and Selecting

The server may select Evidence Documents (or requirements) to display using different rules determined by the administrator to optimize between prediction accuracy and exploration of the landscape. The user may be shown some Evidence Documents (or requirements) that best match what they appear to be looking for and some Evidence Documents (or requirements) that demonstrate alternative services/results that they had not thought about.

For a given Requirement Document inferred or confirmed to be described by a plurality of topics, the Matching Engine 150 may identify, from the topic model database 25, a set of Evidence Documents that (a) are highly probably described by an individual topic; (b) are highly probably described by all topics; and/or (c) have a topic vector most similar to the Requirement Document, i.e. described by topics with a probability in a similar ratio and magnitude. An Evidence Document's topic probability measured (a) individually, (b) aggregate or (c) vector cosine similarity may be used as its similarity score to rank Evidence Documents and select a set of most similar Evidence Documents to display.

For example, in FIG. 4, the Topic Inference agent infers that that the requirements are described by Topic1 (50% likely) and Topic 2 (45% likely), ignoring the remaining topics as unlikely. FIG. 5 continues the process, in which the Topics 1 and 2 have been confirmed (box 500) by the user. The Matching Engine retrieves (520) from the topic model database 25: Case 1 as the best example of Topic 1 (80% likely); Case 2 as the best example of Topic 2 (75% likely); and Case3 as having the most similar vector of Topics 1 and 2 to the vector for the Requirement Document. The associated vendors are retrieved (510) from the B2B organization database. The best cases and their vendors are displayed (540). The Engine may aggregate the evidence scores by vendor to recommend Vendor1 as a supplier to two close cases.

The document similarity metric may also be calculated using many known ways in computing science. In a topic model approach, documents are described by the topic distribution and between documents the distributions can be similarity scored using any types of f-divergence such as Kullback-Leibler divergence, Hellinger distance, or total variation distance. In a vector space model approach, the similarity score between two documents may be calculated by some distance functions such as Euclidean distance or cosine similarity, e.g. computing a dot product of two vectors of features. The scoring agent may also score vendors, preferably using the sum of the score of their associated Evidence Documents, more preferably only including their Evidence Documents above a threshold similarity value.

### Data Source

The system's data input agent provide one or more ways to input a business Evidence Document to the database, such as a website data entry form, receiving a data file, an API callable by third-party software, or a web crawler. The Evidence Document may be input by a user working on behalf of one of the organizations in the relevant relationship and comprises details about the relationship and the other organization. In one embodiment, a web crawler scours the webpages of vendor organizations and/or news websites to find case studies of services/products provided to a client. Evidence Documents may be stored on one or more databases within the present system but they could be stored on remote databases, such as storage devices operated by vendors, in which case a modeled representation of the Evidence Document is stored locally with the location of the remote storage.

In certain embodiments, a user inputs the Evidence Document data. The user may input the Evidence Document details into a user-interface provided by the web server. A document comprises text, preferably comprising at least 100 words, more preferably at least 250 words. Common words and highly unusual words are unhelpful to some machine models but are useful to both author and human readers. While the system does not control the user's authorship of the document, a document building agent via the UI may encourage the user to input a useful document by asking for more words or suggesting descriptive words. The greater the number of words and more topic-specific they are, the more accurate the Engine will be in comparing documents.

As shown in FIG. 6, the buyer-user may explicitly enter their own industry and services required from a drop-down menu. The User Interface may provide all possible industry and services in the database or narrow the options down to those inferred from the user's Requirement Document. This explicit selection increases the likelihood that the matching Engine will identify vendors and Evidence Documents that do provide those services to that industry but requires that they be tagged as such.

Where the Evidence Document comprises a non-text work sample such as a logo, design, web page layout, graphic, video, or radio ad, the document-building agent prompts the user to add some text description or tags (as discussed below). The document-building agent may use machine techniques such as image processing, optical character recognition, and speech recognition to automatically determine keywords relevant to the work sample. Similarly the Requirement Document be entered by speech or as an image, which is tagged, further described in text, or processed to determine keywords.

For example, a vendor-user may submit a JPEG of a magazine ad for a car with the client logo and a description of the car. The document-building agent examines the image for text using optical character recognition, logos using image matching tools, and objects using image recognition. These are displayed to the user for selection/delection.

### Document Improvement

In preferred embodiments, the document-building agent helps users build a better document, such as a more compelling Evidence Document. This agent may help the user enter their documents into the appropriate parts, such as situation, industry, problem, services provided, methodology and results. This agent then shows example keywords or documents from organizations similar to the user's, preferably from real-time matching of the user's text entry to the collection of documents. The agent may determine and display keywords of similar documents that are not used in the immediate document.

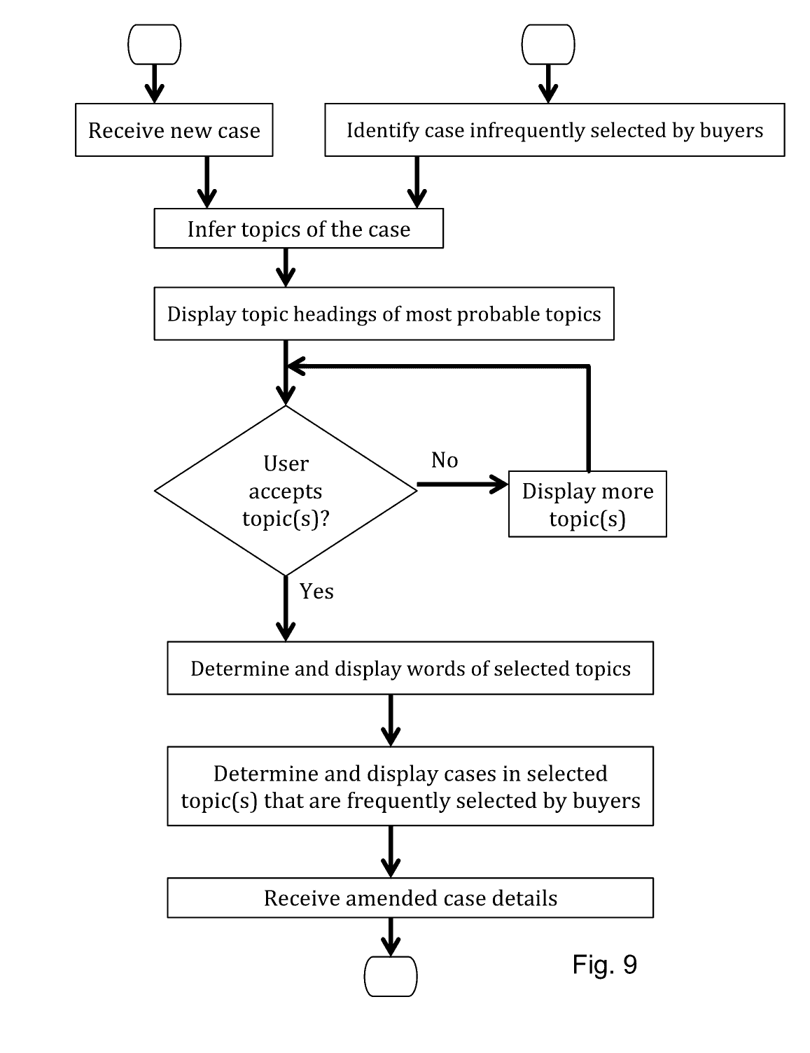

For example, as shown in FIG. 9, the agent may use the topic model to infer the most probable topics that describe a new Evidence Document. Topic headers from a plurality of the most probable topics are shown to the vendor-user. If the vendor-user does not agree with the topic suggestions or there is low computed confidence in the suggested topics, then the agent displays more topics. Alternatively the agent suggests that the vendor alter or add more words to describe the Evidence Document. If the vendor selects a topic that has a low degree of match, then the agent determines which common terms are frequently used for the selected topic(s) but are not in the vendor's Evidence Document, and displays these words. The agent may also display example Evidence Documents in the selected topic.

The process flow may be similar to finding Evidence Documents for buyer-users, although here the Matching Engine finds Evidence Documents similar to the Evidence Document being entered and displaying them to the vendor-user, and may repeat this for each part of the Evidence Document. Compared to Requirement Documents, Evidence Documents' parts and formats should be more similar. Receiving selection(s) of similar Evidence Documents from the vendor-user, confirms the topic inference and narrows the collection of Evidence Documents to consider when inferring the topic of subsequent parts of the new Evidence Document being entered. The server may display Evidence Documents that are both similar and commonly selected by buyer-users in their own selection process. The vendor-user can thus see in real-time what words and semantics are used in successful Evidence Documents and thus amend their own description.

The document-building agent may also function offline, sending suggestions to a user for improvement from time to time. The agent may communicate to a vendor that their Evidence Document terminology is unconvincing to buyer-users or wrongly modeled by the system using the current words. The agent determines which documents have been displayed on multiple occasions and yet are rarely selected, in comparison to other documents, particularly within the same topic(s). The server communicates to the user associated with the infrequently selected document keywords, documents or topic headers of the more frequently selected documents. A user-interface will enable them to amend their wording or select/deselect topics associated with their document.

### Tagging Documents

As discussed, an Evidence Document defines products or services required or provided, and is itself defined by the words in the document, which can be converted by machine learning into topic headers or feature vectors. To improve upon the machine-determined keywords, the system may comprise a tagging agent to tag or label a document.

These tags may more accurately identify the document or emphasize the keywords that the user wants to convey. Advantageously, this prompts the user to define their project or their organization in useful terms they did not enter into the free-text box. For example the UI may ask questions of the user about the Evidence Document or relevant organizations. Some of these tags may be attributes such as size, location, industry, customer markets, services/products and specialties. The tags may be structured into tag categories or unstructured. The tag values may be limited to predefined values or may be free-form tag values.

These may be tags about the Evidence Document and/or organization involved. The organization database 5 may have data about the client, buyer, or vendor attributes, which may be used where organizations are identified. However, the user may want to tag an organization referenced in a document with different attributes to emphasize something. For example, a client may work in many industries but, for their present Evidence Document, only one industry tag is relevant.

These tags may be auto-generated by the tagging agent and/or submitted by a user via the user interface. The tagging agent may predict values for each category of tags using the text description and display this as a suggestion to the user in the UI. The user may select/deselect the suggested values and/or enter their own values.

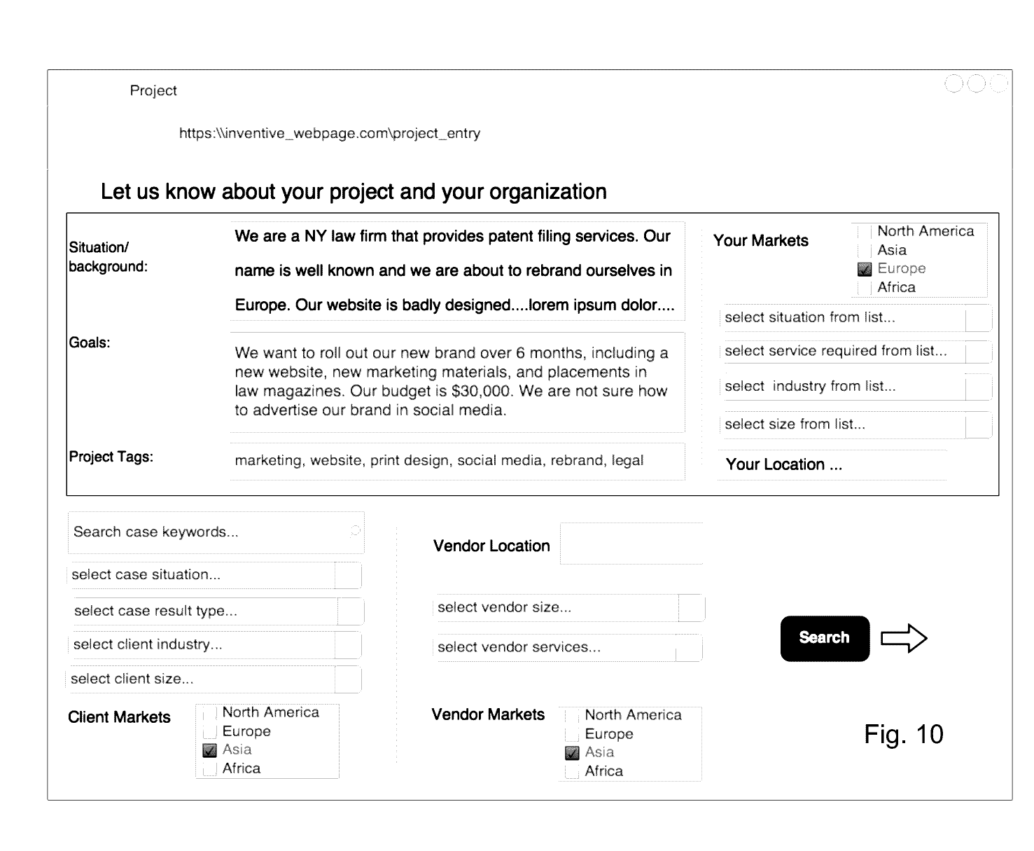

FIG. 10 illustrates a web interface which enables a user to enter text describing their requirement, enter project tags, and select or enter attribute values.

In one embodiment, the tagging agent parses the text for words or n-grams that are compatible with each tag category, e.g. cities are compatible with location tags, names are compatible with client tags, numbers are compatible with financial tags, etc. Alternatively the tagging agent may use the modeler to determine topic headers or features of the document and then determine which of these modeled keywords are compatible with each tag category. For each tag category, the system may comprise a vocabulary or model against which, the actual words or modeled keywords in the document are matched. Tools such as Named-Entity Recognition, from libraries such as GATE, NETagger, OpenNLP, Alchemy API (from IBM), and Stanford CoreNLP may be used to identify entities such as locations, companies, people, and quantities from the document text.

For example, a word may be identified as a city by a tool, such as Geocoder, which the tagging agent then suggests as a value for the location tag. In another example, the probable topic(s) of the Requirement Document may be determined and linked to one or more generic situations, service requirements, or goals stored in a database, and then prepared as natural text for display to the user. In FIG. 10, the user's requirement for goals may be modeled by the keyword vector “marketing, law, brand, website, social media,” for which the tagging agent identifies generic service suggestions: a) “I need a website, b) “I need legal services”, c) “I want help with branding/rebranding”, and d) “I want help with social media marketing.” The user selects the suggested generic sentences, which confirms their own words and links the requirement to a known cluster of topics.

The tagging agent may also use tags (or labels) given to topic(s) that the document is likely discussion. For example, in LLDA an administrator labels the few hundred topic clusters (instead of the many thousand documents), the topic inference agent assigns a new document one or more topics and the tagging agent uses these topic's labels as tags for the new document. The user interface may permit the user to amend these tags.

Similar to the requirements example of FIG. 10, a vendor-user may input an Evidence Document and the tags for the situation, methodology, services provided, dates, results, and metrics as well as attributes for the relevant client.

### Match Documents by Tags

An advantage of tagging Evidence Documents or Requirement Documents is that tags may be used to cluster documents, match documents, or calculate similarity. For example, the user can more specifically search for an organization (vendor or buyer), based on tags about the associated documents (Evidence Document or requirements). There is less chance of a document being displayed because it just happened to use a certain word. Moreover the user can search by parameters not present explicitly in their own document. For example, in FIG. 10 (top) the features “patent filing services” and “website” may both be modeled as describing the buyer and it is not clear whether the buyer would prefer a vendor located in NY, Europe or somewhere else.

Thus in certain preferred embodiments, the document modeler clusters documents by one or more tags and the matching Engine selects and scores documents, at least partly based on one or more tags. The user interface may provide tag filters and keyword search fields for selecting and scoring documents and/or organizations (vendor/client/buyer).

These search parameters are passed to the matching Engine with the document text. The matching Engine may use these search parameters as absolute requirements for selection or merely to score the best matches. For example, the user may require that the system find Evidence Documents limited to marketing services, preferably involving clients with certain attributes.

In the UI shown in FIG. 10 (bottom), the user can search for keywords in Evidence Documents, select pre-defined, generic Evidence Document situations and results, or filter by client and vendor attributes.

The selection and scoring of documents and associated organizations may be based partly on tag similarity and partly based on the modeled similarity of the natural language text. The selection and scoring may also be based on other criteria, such as client similarity and social connection as taught in patent application U.S. Ser. No. 14/537,092, U.S. 62/101,952, incorporated herein by reference.

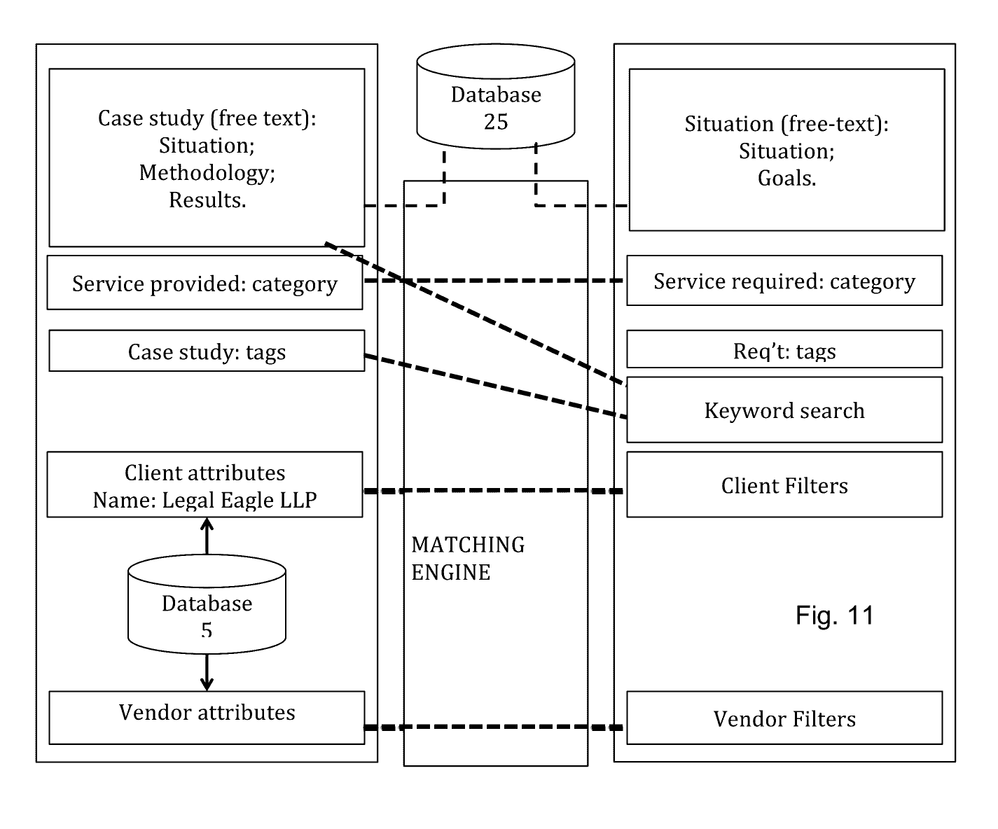

In FIG. 11, the matching Engine compares an Evidence Document to a Requirement Document using a weighted combination of similarity scores between equivalent parts. The user's services selection(s) are used to select/deselect Evidence Documents based on their service categories. The user's client and vendor filters are used to score Evidence Documents based on the client and vendor attributes. The topic model database 25 and agents score the similarity of the free-text portions of the documents. The user's keyword(s) query is used to select and score Evidence Documents having those words or tagged with those words.

### Reuse of Requirement Document

An advantage of entering the user's requirements as a structured text document in natural language is that the document may be sent to the selected vendors without need for re-entering a description of their requirements into natural language. For example, the Requirement Documents may be reused as an RFP to be sent to selected vendors. Thus the user does not need to 1) structure a query to suit the computer search fields by keywords, imperfect ontology and limited filters, nor 2) write an additional document explaining their needs to a human reader. The structured nature of the document ensures that the RFP sent is in a comparable format to other RFPs sent by other buyers and contains sufficient detail for a vendor to provide a meaningful response. In preferred embodiments, the system stores the Requirement Document in memory and electronically communicates the document to a plurality of vendors.

FIG. 6 (bottom) illustrates how vendors selected via check boxes may subsequently be sent the Requirement Document. The process may comprise an additional step allowing the buyer-user to amend their requirements for vendors or attach additional documents.

Further details for operating an RFP process in a network of organizations see co-pending application DOCKET P009.

### Anonymity

In certain embodiments, the user interface provides for an option to mark the other organization as ‘anonymous’, i.e. to be hidden from other users. Equivalently the user selects the other organization's ‘visibility’ towards other users. This status is stored as a flag in the relationship record. Although the system records the identity of the potential client, their peers, the selected vendors and their clients, in preferred embodiments the system does not display all of these identities to all users. Determining whether an organization is identified or anonymized in a display may be based on: (a) an anonymity status of an organization in a relationship in the database; (b) an anonymity status of an organization in an Evidence Document in the database; or (c) system rules designed to ensure user's actions are unbiased.

In one embodiment, the system passes the requirements to the vendors without revealing the potential client's identity. The system may display attribute data of the potential client to assist the vendor in deciding whether and how to respond to the requirements.

In another embodiment, the system displays the Evidence Documents to the buyer without revealing the identity of the related vendors. The client-user is thus able to select the most relevant Evidence Documents without being biased by the identity of the vendors.

### Display

The system receives queries and communicates results to users via a user interface on the user's computing device. The system prepares web content from the vendor and evidence data objects. A serialization agent serializes the web content in a format readable by the user's web browser and communicates said web content, over a network, to a client's or vendor's computing device.

Display of a vendor means that data elements identifying a vendor are retrieved from a vendor data object in the database, serialized and communicated to client computing device 10, 11 for consumption by the user. Display of an Evidence Document may similarly be made by displaying the text from the document or a multi-media file (e.g. JPEG, MPEG, TIFF) for non-text samples of work that are linked to the Evidence Document.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” and “I” (the slash mark) between alternatives is to be understood in the inclusive sense, whereby either alternative and both alternatives are contemplated or claimed.

Reference in the above description to databases are not intended to be limiting to a particular structure or number of databases. The databases comprising Evidence Documents or business relationships may be implemented as a single database, separate databases, or a plurality of databases distributed across a network. The databases may be referenced separated above for clarity, referring to the type of data contained therein, even though it may be part of another database. One or more of the databases and agents may be managed by a third party in which case the overall system and methods or manipulating data are intended to include these third party databases and agents.

For the sake of convenience, the example embodiments above are described as various interconnected functional agents. This is not necessary, however, and there may be cases where these functional agents are equivalently aggregated into a single logic device, program or operation with unclear boundaries. In any event, the functional agents can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

Further explanation of some technique discussed above may be found in the following references:
Blei, D. M., Ng, A. Y., & Jordan, M. I. (2003). Latent Dirichlet Allocation. The Journal of Machine Learning Research, 3, pp. 993-1022.
Document Clustering Based On Non-negative Matrix Factorization Wei Xu, Xin Liu, Yihong Gong NEC Laboratories America, Inc. 10080 North Wolfe Road, SW3-350 Cupertino, Calif. 95014, U.S.A.
Xu, Wei, Xin Liu, and Yihong Gong. “Document clustering based on non-negative matrix factorization.” Proceedings of the 26th annual international ACM SIGIR conference on Research and development in information retrieval. ACM, 2003.
Griffiths, D. M. B. T. L., and M. I. J. J. B. Tenenbaum. “Hierarchical topic models and the nested Chinese restaurant process.” Advances in neural information processing systems 16 (2004): 17.
Jagarlamudi, Jagadeesh, Hal Daumé III, and Raghavendra Udupa. “Incorporating lexical priors into topic models.” Proceedings of the 13th Conference of the European Chapter of the Association for Computational Linguistics. Association for Computational Linguistics, 2012.
Islam, Aminul, and Diana Inkpen. “Semantic text similarity using corpus-based word similarity and string similarity.” ACM Transactions on Knowledge Discovery from Data (TKDD) 2.2 (2008): 10.
Wallach, Hanna M. “Topic modeling: beyond bag-of-words.” Proceedings of the 23rd international conference on Machine learning. ACM, 2006.

1. A computer-implemented method comprising:
one or more processors receiving a Requirement Document from a user;
the one or more processors comparing the Requirement Document to Evidence Documents in a database to determine a set of similar Evidence Documents; and
the one or more processors communicating a plurality of the similar Evidence Documents to the user,
wherein the Requirement Document comprises text describing an organization's requirement for a product or service and
wherein the Evidence Documents comprise text describing a product or service already provided by a vendor.

2. The method of claim 1, further comprising the one or more processors:
receiving a selection from the user of one or more of the communicated Evidence Documents; and
identifying vendors associated, in the database, with the user-selected Evidence Documents and displaying these vendors to the user.

3. The method of claim 1, further comprising the one or more processors identifying vendors associated, in the database, with the set of similar Evidence Documents and displaying a plurality of these vendors to the user.

4. The method of claim 1, wherein the Requirement Document and Evidence Documents each comprise a plurality of parts, a first part defining a situation of the user's organization or of a client and a second part defining a result to be achieved for the buyer or already achieved for the client; and
wherein comparing documents comprises comparing the corresponding parts of the documents.

5. The method of claim 1, further comprising:
creating a document model of the Evidence Documents; and
applying the model to the Requirement Document to determine the set of similar Evidence Documents.

6. The method of claim 5, wherein the document model is further created from other Requirement Documents entered by other users and stored in the database.

7. The method of claim 5, wherein creating the model comprises topic modeling or vector space modeling, preferably using one of: Latent Dirichlet Association, Labeled Latent Dirichlet Association, or Non-Negative Matric Factorization.

8. The method of claim 1, further comprising the one or more processors determining a plurality of clusters of the set of similar Evidence Documents and communicating the clusters to the user.

9. The method of claim 8, further comprising the one or more processors receiving the user's selection of one or more of the clusters, and identifying Evidence Documents in the database associated with the user-selected clusters to determine the plurality of similar Evidence Documents to communicate to the user.

10. The method of claim 1, further comprising:
the one or more processors building a topic model from Evidence Documents in the database; and
the one or more processors inferring one or more topics describing the Requirement Document using the topic model.

11. The method of claim 10, further comprising:
communicating the inferred topics to the user;
receiving the user's selection of one or more of the inferred topics; and
identifying Evidence Documents in the database associated with the user-selected topics to determine the plurality of similar Evidence Documents to communicate to the user

12. The method of claim 11, further comprising:
determining text features from the one or more topics inferred to describe the Requirement Document; and
communicating the text features to the user to represent the inferred topics;

13. The method of claim 1, further comprising the one or more processors calculating a metric of similarity between the Requirement Document and Evidence Documents and wherein the set of similar Evidence Documents is selected based on the metric of similarity, preferably selecting only Evidence Documents having a similarity value above a threshold.

14. The method of claim 1, further comprising the one or more processors communicating the Requirement Document to users associated with some of the selected vendors.

15. A computer-implemented method comprising:
one or more processors receiving an Evidence Document from a user;
the one or more processors comparing the Evidence Document to Requirement Documents in a database to determine a set of similar Requirement Documents;
the one or more processors communicating a plurality of the similar Requirement Documents to the user;
the one or more processors receiving a selection from the user of one or more of the communicated Requirement Documents;
the one or more processors identifying which buyers are associated in the database with the selected Requirement Documents and communicating identities of the buyers to the user.

16. A computer-implemented method comprising:
one or more processors identifying a first document describing services required or performed by a first organization;
the one or more processors identifying, from a database, a set of similar documents having text features similar to the first document;
the one or more processors communicating a plurality of the similar documents to a user associated with the first organization;
the one or more processors receiving a selection from the user of one or more of the communicated similar documents;
the one or more processors identifying which second organizations are associated, in the database, with the selected similar documents and providing a communication agent for the user to contact these second organizations.
